(19) United States
(12) Patent Application Publication
(10) Pub. No.: US 2014/0199579 A1
(43) Pub. Date: Jul. 17, 2014

(54) NEGATIVE ELECTRODE ACTIVE MATERIAL FOR NONAQUEOUS ELECTROLYTE SECONDARY BATTERY, NONAQUEOUS ELECTROLYTE SECONDARY BATTERY AND BATTERY PACK

(71) Applicant: KABUSHIKI KAISHA TOSHIBA, Tokyo (JP)

(72) Inventors: Tomokazu MORITA, Chiba (JP); Takashi KUBOKI, Tokyo (JP); Takayuki FUKASAWA, Kanagawa (JP); Yasuyuki HOTTA, Tokyo (JP); Kenji ESSAKI, Kanagawa (JP); Norikazu OSADA, Tokyo (JP)

(73) Assignee: KABUSHIKI KAISHA TOSHIBA, Tokyo (JP)

(21) Appl. No.: 14/215,158

(22) Filed: Mar. 17, 2014

Related U.S. Application Data
(63) Continuation of application No. PCT/JP2012/057460, filed on Mar. 23, 2012.

(51) Int. Cl. H01M 4/36; H01M 4/48; H01M 4/583

(52) U.S. Cl. CPC H01M 4/364; H01M 4/583; H01M 4/48
USPC 429/156; 429/231.8; 252/507

(57) ABSTRACT

A negative electrode active material for a nonaqueous electrolyte secondary battery has a carbonaceous substance, a silicon oxide phase in the carbonaceous substance, a silicon phase in the silicon oxide phase, and a zirconia phase in the carbonaceous substance. The negative electrode active material has a diffraction peak at 2θ=30±1° in powder X-ray diffraction measurement.

### CROSS-REFERENCE TO RELATED APPLICATION

This application is a continuation application based upon and claims the benefit of priority from International Application PCT/JP2012/057460, the International Filing Date of which is Mar. 23, 2012 the entire contents of which are incorporated herein by reference.

### FIELD

Embodiments described herein relate generally to a negative electrode active material for a nonaqueous electrolyte secondary battery, a nonaqueous electrolyte secondary battery and a battery pack.

### BACKGROUND

In recent years, various portable electronic devices have become widespread due to rapid development of techniques for downsizing electronics devices. Batteries as power supplies of these portable electronic devices are required to be downsized, and nonaqueous electrolyte secondary batteries having a high energy density receive attention.

Particularly, attempts have been made to use substances having a high lithium storage capacity and a high density, such as elements that form an alloy with silicon or tin, and amorphous chalcogen compounds. Among them, silicon is capable of storing lithium at a ratio of up to 4.4 lithium atoms per silicon atom, and has a negative electrode capacity per mass which is about 10 times as high as that of graphitic carbon. However, silicon undergoes a significant change in volume associated with insertion and desorption of lithium in a charge-discharge cycle, and has a problem in life cycle due to size reduction of active material particles or the like.

The inventors have extensively conducted experiments, and resultantly found that when fine silicon monoxide and a carbonaceous substance are compounded and fired, an active material is obtained in which microcrystalline Si is dispersed in a carbonaceous substance while being included in or held by SiO₂ which is strongly bound with Si, so that capacity enhancement and improvement of cycle characteristics can be achieved. However, even with such an active material, the capacity decreases when several hundred charge-discharge cycles are performed, and therefore life characteristics are not sufficient for a long time of use.

Further, as a result of conducting close studies on a process of decrease in capacity, it has been found that microcrystalline Si is grown while charge-discharge is repeated, so that the crystallite size is increased. The problem is that due to the growth of the crystallite size, influences of a change in volume associated with insertion and desorption of Li during charge-discharge become significant, leading to a decrease in capacity.

### BRIEF DESCRIPTION OF THE DRAWINGS

FIG. 1 is a conceptual view of a negative electrode active material of an embodiment;

FIG. 2 is a chart illustrating a method for production of a negative electrode active material of an embodiment;

FIG. 3 is a conceptual view of a nonaqueous electrolyte secondary battery of an embodiment;

FIG. 4 is an enlarged conceptual view of a nonaqueous electrolyte secondary battery of an embodiment;

FIG. 5 is a conceptual view of a battery pack of an embodiment;

FIG. 6 is a block diagram illustrating an electric circuit of a battery pack; and

FIG. 7 is a spectrogram from powder X-ray diffraction measurement of negative electrode active materials of examples and comparative example.

### DETAILED DESCRIPTION

A negative electrode active material for a nonaqueous electrolyte secondary battery of an embodiment includes, a carbonaceous substance, a silicon oxide phase in the carbonaceous substance, a silicon phase in the silicon oxide phase, and a zirconia phase in the carbonaceous substance. The negative electrode active material has a diffraction peak at 2θ=30±1° in powder X-ray diffraction measurement.

A nonaqueous electrolyte secondary battery of an embodiment includes a negative electrode containing a negative electrode active material, a positive electrode containing a positive electrode active material and a nonaqueous electrolyte. The negative active material includes a carbonaceous substance, a silicon oxide phase in the carbonaceous substance, a silicon phase in the silicon oxide phase, and a zirconia phase in the carbonaceous substance. The negative active material has a diffraction peak at 2θ=30±1° in powder X-ray diffraction measurement.

A battery pack of an embodiment using a nonaqueous electrolyte secondary battery includes a negative electrode containing a negative electrode active material, a positive electrode containing a positive electrode active material, and a nonaqueous electrolyte. The negative electrode active material includes a carbonaceous substance, a silicon oxide phase in the carbonaceous substance, a silicon phase in the silicon oxide phase, and a zirconia phase in the carbonaceous substance. The negative electrode active material has a diffraction peak at 2θ=30±1° in powder X-ray diffraction measurement.

A method for production of a negative electrode active material for a nonaqueous electrolyte secondary battery, includes mixing SiOₓ (0.8≦x≦1.5), a zirconium compound, a resin, and at least one carbon material selected from the group consisting of graphite, coke, low-temperature-fired carbon and pitch, and firing the mixture at a temperature of 1000° C. to 1400° C. (inclusive).

Embodiments will be described below with reference to the drawings.

### First Embodiment

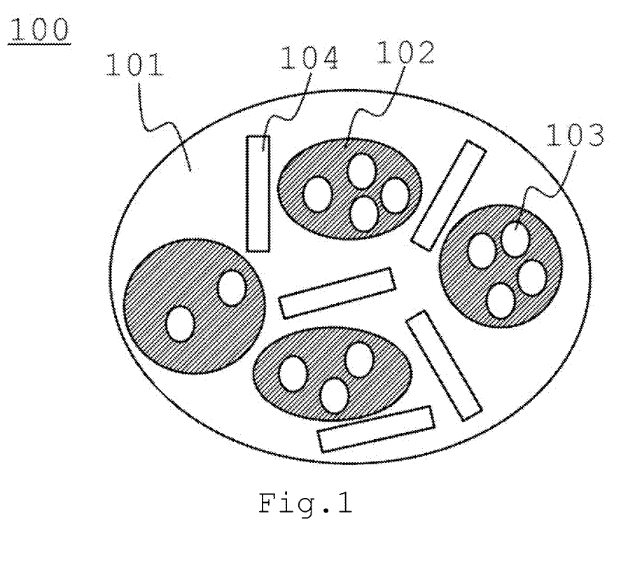

As illustrated in the conceptual view of FIG. 1, a negative electrode active material 100 of the first embodiment includes a carbonaceous substance 101, a silicon oxide phase 102 in the carbonaceous substance 101, a silicon phase 103 in the silicon oxide phase 102 and a zirconia phase 104 in the carbonaceous substance 101.

The negative electrode active material 100 is particles containing silicon that inserts and desorbs Li. Preferably the negative electrode active material 100 is particles having an average primary particle diameter of 5 μm to 100 μm (inclusive) and a specific surface area of 0.5 m²/g to 10 m²/g (inclusive). The particle diameter and the specific surface area of the active material affect the speed of an insertion and desorption reaction of lithium, and has significant influences on negative electrode characteristics, but as long as the average primary particle diameter and the specific surface area fall within the above-mentioned ranges, characteristics can be stably exhibited. An average primary particle diameter is determined by averaging the particle diameters of ten negative electrode active material particles selected at random from a SEM image. A specific surface area is determined by performing pore distribution measurement using a mercury penetration method.

The carbonaceous substance 101 of the embodiment is a conductive material and is compounded with the silicon oxide phase 102 and the zirconia phase 104. The carbonaceous substance 101 forms a negative electrode active material. As the carbonaceous substance 101, at least one selected from the group consisting of graphite, hard carbon, soft carbon, amorphous carbon and acetylene black can be used. Among them, graphite alone or a mixture of graphite and hard carbon is preferred for the following reasons. Graphite is preferred as the carbonaceous substance 101 of the negative electrode active material 100 in that conductivity of the active material is enhanced. Hard carbon is preferred as the carbonaceous substance 101 of the negative electrode active material 100 in that the whole of the active material is coated to significantly alleviate expansion and contraction. The above-described compounding includes both the forms in which the silicon oxide phase 102 and the zirconia phase 104 are included in and held by the carbonaceous substance 101.

The negative electrode active material 100 may be coated with a compound that is the same in type as the carbonaceous substance 101 mentioned above. When the negative electrode active material 100 is coated, there is the advantage that the negative electrode active material 100 has excellent conductivity because the silicon oxide phase 102 and the zirconia phase 104 are not exposed but coated with a carbon-based compound.

The silicon oxide phase 102 of the embodiment exists in the carbonaceous substance 101 in the form of particles. The silicon oxide phase 102 includes a compound having an amorphous structure, a low-crystalline structure, a crystalline structure or the like and represented by the chemical formula of SiO_{y} (1<y≦2). The silicon oxide phase 102 is physically bound with the silicon phase 103 to include or hold the silicon phase 103. When the silicon oxide phase 102 is agglomerated, silicon oxide phases 102 are bound together, so that the silicon oxide phase is coarsened. Use of the negative electrode active material 100 having the coarsened silicon oxide phase 102 for the secondary battery is not preferred because the degradation rate of cycle characteristics thereof is increased. Preferably the silicon oxide phase 102 is dispersed in the carbonaceous substance 101 for preventing agglomeration of the silicon oxide phase 102.

When the size of the silicon oxide phase 102 is small and variations in size of the phase are small, agglomeration of the silicon phase 103 and coarsening of the phase are hard to occur. A secondary battery using, for the negative electrode, the negative electrode active material 100 with the silicon phase 103 prevented from being agglomerated and coarsened has improved life characteristics due to a decrease in volume degradation rate associated with charge-discharge cycles. A preferred average maximum diameter of the silicon oxide phase 102 is in a range of 50 nm to 1000 nm. When the average maximum diameter exceeds this range, an effect of suppressing agglomeration of the silicon phase 103 cannot be obtained. When the average maximum diameter falls below the above-mentioned range, it is difficult to disperse the silicon oxide phase 102 in the carbonaceous substance 101 at the time of preparing an active material, and there is the problem that rate characteristics are deteriorated due to a reduction in conductivity as an active material or initial charge-discharge volume efficiency is reduced, etc. The average maximum diameter is further preferably 100 nm to 500 nm (inclusive), and proper life characteristics can be obtained as long as the average maximum diameter is in this range. The average maximum diameter of the phase is a value obtained by observing a cross section of the negative electrode active material 100 by SEM-EDX ((Scanning Electron Microscope Energy Dispersive X-ray Spectrometer) and averaging the largest diameters of diameters of phases identified as the silicon oxide phase 102. For calculating an average value, ten or more samples are used.

For obtaining proper characteristics as the active material as a whole, variations in size of the silicon oxide phase 102 are preferably as small as possible. When a 16% cumulative diameter is d16% and a 84% cumulative diameter is d84% in terms of a volume with the phase considered as particles, a value of (standard deviation/average size) where the standard deviation is represented by (d84%−d16%)/2 is preferably 1.0 or less, and when the value is 0.5 or less, excellent life characteristics can be obtained. An average size (volume average) and a standard deviation defined as (d84%−d16%)/2 are determined in the following manner. A cross section of a SEM image is photographed for the synthesized negative electrode active material 100 after firing. Using SEM image analysis software (Mac-View (registered trademark) manufactured by Mountech Co., Ltd.), the photographed image is analyzed with the phase considered as particles, thereby obtaining particle diameter distribution data. From the obtained particle diameter distribution data, an average size (volume average), a standard deviation defined as (d84%−d16°)/2 and a value of (standard deviation/average size) are calculated.

The silicon phase 103 of the embodiment includes crystalline silicon that inserts and desorbs lithium. The silicon phase 103 exists in the silicon oxide phase 102 and is preferably included in or held by the silicon oxide phase 102. It is preferred that the size of the silicon phase 103 is small because the amount of expansion and contraction associated with insertion and desorption of lithium is decreased. It is not preferred that the silicon phase 103 is large because, when the silicon phase 103 expands, the negative electrode active material 100 is reduced in particle size due to occurrence of cracks in the carbonaceous substance 101, etc. Thus, the average maximum diameter of the silicon phase 103 is preferably several nm to 100 nm (inclusive). Since the silicon phase 103 is easily coarsened as the phase is bound through expansion, it is preferred that the silicon phase 103 is dispersed in the silicon oxide phase 102. Expansion and contraction occurring as a large amount of lithium is inserted into and desorbed from the silicon phase 103 is alleviated by being distributed to the silicon oxide phase 102 and the carbonaceous substance 101 and thereby to prevent a reduction in size of active material particles. The average maximum diameter of the silicon phase 103 can be determined in the same manner as in the case of the average maximum diameter of the silicon oxide phase 102.

A ratio of the silicon phase 103 to the carbonaceous substance 101 is more preferably in a range of 0.2≦Si/C≦2 in terms of a molar ratio of the Si element of the silicon phase 103 to the C element of the carbonaceous substance 101 because a high capacity and excellent large current characteristics can be maintained. A molar ratio of the Si element of the silicon phase 103 to SiO_{y} of the silicon oxide phase is desired to be 0.6≦Si/SiO_{y}≦1.5 because a high capacity and proper cycle characteristics can be obtained as the negative electrode active material 100.

The zirconia phase 104 of the embodiment includes one or both of zirconia and stabilized zirconia. A stabilizer for zirconia is an oxide of yttrium, calcium, magnesium or hafnium. The zirconia phase 104 exists in the carbonaceous substance 101. Preferably the zirconia phase 104 is distributed in the vicinity of the silicon oxide phase 102 for preventing agglomeration and coarsening of the silicon oxide phase 102.

The zirconia phase 104 physically suppresses fusion of silicon oxide particles. During firing of a precursor of the negative electrode active material 100, zirconia undergoes phase transition to contract the volume of zirconia, so that a hole is generated in the carbonaceous substance 101. The hole may alleviate expansion and contraction associated with storage and release of lithium by the silicon phase 103, leading to improvement of cycle life. Zirconia undergoes phase transition from a monoclinic crystal to a tetragonal crystal when fired at around 1000° C. Tetragonal crystal zirconia has XRD diffraction peaks attributed to (101), (112) and (211) of the crystal structure, at 2θ=30°, 50° and 60°, respectively. Monoclinic crystal zirconia has no XRD diffraction peaks at 2θ=30°, 50° and 60°. Some peak shift occurs depending on a type of the stabilizer for zirconia. Thus, when the negative electrode active material 100 of the embodiment includes tetragonal crystal zirconia, an XRD diffraction peak is present at 2θ=30±1°. A ratio of a peak area B of the diffraction peak of the (101) plane of tetragonal crystal zirconia to a peak area A of silicon (111) observed at around 2θ=28° (B/A) is preferably 0.05 to 0.5 (inclusive). When the ratio (B/A) is less than 0.05, the hole formation effect is not sufficient, and when the ratio (B/A) is more than 0.5, the amount of silicon contained in the active material decreases.

Further, zirconia may partially react with silicon oxide to form zircon (ZrSiO₄). Since zircon is generated at an interface between the silicon oxide phase 102 and the zirconia phase 104, binding is strengthened, so that the strength of the composite is improved.

The added amount of zirconia is preferably 0.001≦Zr/Si≦0.200 in terms of a molar ratio of the Si element of the silicon oxide phase 102 and the silicon phase 103 and the Zr element of the zirconia phase 104. This is because when the added amount of zirconia is in this range, the negative electrode active material 100 having a high capacity, a long life and excellent large current characteristics can be obtained. The added amount of zirconia is especially preferably in a range of 0.01 to 0.15 (inclusive) in terms of a molar ratio of Zr/Si. For added zirconia to retain a dispersed state in the carbonaceous substance 101, the average maximum diameter of the zirconia phase 104 is preferably 0.1 to 10 times, especially preferably 0.2 to 2 times as large as that of the silicon oxide phase 102.

Preferably carbon fibers are included in the carbonaceous substance 101 for retaining the structure of particles, and preventing agglomeration of the silicon oxide phase 102 to secure conductivity. It is effective that carbon fibers to be added have a diameter comparable to a size of the silicon oxide phase 102, and the average diameter is preferably 50 nm to 1000 nm (inclusive), especially 100 nm to 500 nm (inclusive). The content of carbon fibers is preferably in a range of 0.1% by mass to 8% by mass (inclusive), especially preferably 0.5% by mass to 5% by mass (inclusive), based on the mass of the negative electrode active material 100. The average diameter of carbon fibers is an average diameter of ten carbon fibers selected at random from a SEM image.

Alkoxide and a Li compound may be contained in the carbonaceous substance 101. When these substances are contained, binding of SiO₂ contained in the silicon oxide phase 102 and the carbonaceous substance 101 is strengthened, and Li₄SiO₄ having excellent Li ion conductivity is generated in the silicon oxide phase 102. Examples of the alkoxide include silicon ethoxide. Examples of the Li compound include lithium carbonate, lithium oxide, lithium hydroxide, lithium oxalate and lithium chloride.

Lithium silicate such as Li₄SiO₄ may be dispersed on the surface of or in the silicon oxide phase 102. When heat-treated, a lithium salt added to the carbonaceous substance 101 may undergo a solid reaction with the silicon oxide phase 102 in the carbonaceous substance 101 to form lithium silicate.

The full width at half maximum of the diffraction peak of the Si (220) plane in powder X-ray diffraction measurement of the active material is preferably 1.0° to 8.0° (inclusive). The full width at half maximum of the diffraction peak of the Si (220) plane decreases as the crystal grain of the Si phase is grown, and when the crystal grain of the Si phase is significantly grown, cracking or the like easily occurs in the active material particles due to expansion and contraction associated with insertion and desorption of lithium, but such a problem can be prevented from becoming apparent as long as the full width at half maximum is in a range of 1.0° to 8.0° (inclusive).

(Production Method)

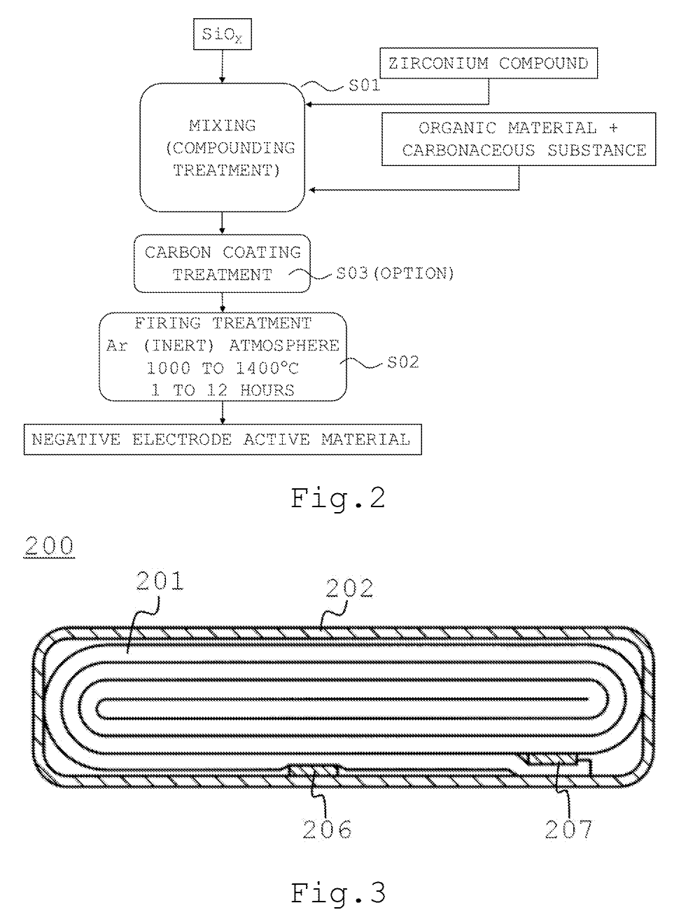

Next, a method for production of the negative electrode active material 100 for a nonaqueous secondary battery according to the first embodiment will be described. The procedure thereof is illustrated in FIG. 2.

In the embodiment, SiOₓ (0.8≦x≦1.5) as silicon oxide, a zirconium compound, a resin as an organic compound, and at least one carbon material selected from the group consisting of graphite, coke, low-temperature-fired carbon and pitch are mixed, and the mixture is fired at a temperature of 1000° C. to 1400° C. (inclusive) to obtain a negative electrode active material.

The negative electrode active material 100 according to the first embodiment can be synthesized by mixing raw materials via a dynamic treatment, a stirring treatment or the like in a solid phase or a liquid phase, and subjecting the mixture to a firing treatment.

(Compounding Treatment: S01)

In the compounding treatment, a silicon oxide raw material and a zirconium compound are mixed, an organic material and a carbon material are added to the mixture, and the mixture is further mixed to form a composite.

The silicon oxide raw material and the zirconium compound can be mixed by a dynamic treatment. Examples of the dynamic treatment may include turbo milling, ball milling, mechano-fusion and disc milling.

Although operation conditions vary depending on a device, it is preferable to perform the treatment until grinding/compounding sufficiently proceeds. However, if the power is excessively increased or an excessive amount of time is spent at the time of compounding, Si reacts with C to generate SiC that is inactive to an insertion reaction of Li. Thus, as treatment conditions, moderate conditions should be defined which allow grinding/compounding to sufficiently proceed and do not cause generation of SiC.

Preferably SiOₓ (0.8≦x≦1.5) is used as a silicon oxide raw material that is a precursor of the silicon phase 103 and the silicon oxide phase 102. Particularly, use of SiC (x≈1) is desirable for obtaining a preferred quantitative ratio between the silicon phase 103 and the silicon oxide phase 102. SiOₓ may be ground at the time of mixing, or SiOₓ in the form of a fine powder may be used. The average primary particle diameter of SiOₓ after micronization is preferably 50 nm to 1000 nm (inclusive). The average primary particle diameter is further preferably 100 nm to 500 nm (inclusive), and SiOₓ that has small variations in particle diameter should be used. The average particle diameter of SiOₓ is a volume average diameter calculated from a particle size distribution obtained in laser light diffraction.

As the zirconium compound that is a precursor of the zirconia phase 104, besides a monoclinic zirconia powder and low-crystalline zirconia as an inorganic material, a zirconium compound such as a zirconium alkoxide, for example zirconium butoxide etc., may be added in the form of a liquid. Zirconia to be added may be doped with an oxide of yttrium, calcium, magnesium, hafnium or the like.

A mixture, an organic material and a carbon material can be compounded by mixing/stirring in a liquid phase. The mixing/stirring treatment can be performed by various kinds of stirrers, ball mills and bead mill apparatuses and a combination thereof. The silicon oxide material, the zirconia compound, the organic material and the carbon material should be compounded by liquid-phase mixing in a liquid using a dispersion medium. In dry mixing, it is difficult to uniformly disperse the silicon oxide material, the carbon material and the zirconia compound without being agglomerated.

As the dispersion medium, an organic solvent, water or the like can be used, but it is preferred to use a liquid having proper affinity with both silicon monoxide and the carbon precursor and carbon material. Specific examples may include ethanol, acetone, isopropyl alcohol, methyl ethyl ketone and ethyl acetate.

As the organic material, an organic compound such as a monomer or oligomer, which is liquid and capable of being easily polymerized, is used. Examples include a furan resin, a xylene resin, a ketone resin, an amino resin, a melamine resin, a urea resin, an aniline resin, a urethane resin, a polyimide resin, a polyester resin and a phenol resin or monomers thereof. Specific monomers include furan compounds such as furfuryl alcohol, furfural and furfural derivatives, and the monomer is polymerized in a mixture of compounding materials. For polymerizing the monomer, hydrochloric acid or an acid anhydride is added.

As the carbon material, at least one selected from the group consisting of graphite, coke, low-temperature-fired carbon, pitch and the like can be used. Particularly, one that is melted when heated, such as pitch, is melted during dynamic milling treatment, so that compounding does not adequately proceed, and therefore such a material should be used in mixture with one that is not melted, such as coke or graphite.

(Firing Treatment: S02)

Firing is performed in an inert atmosphere, e.g. in Ar. In firing, the organic material is carbonized, and SiOₓ is separated into two phases: the silicon phase 103 (silicon) and the silicon oxide phase 102 (SiO_{y}) through a disproportionation reaction. Further, zirconia or stabilized zirconia undergoes phase transition to tetragonal crystal zirconia.

The disproportionation reaction proceeds at a temperature higher than 800° C., and causes separation into the very small silicon phase 103 and silicon oxide phase 102. As the reaction temperature is elevated, the crystal of the silicon phase 103 is grown, so that the full width at half maximum of the peak of silicon (220) decreases. The firing temperature at which a full width at half maximum in a preferred range is obtained is in a range of 850° C. to 1600° C. Si of the silicon phase 103 generated through the disproportionation reaction reacts with carbon to change into silicon carbide at a temperature higher than 1400° C. Silicon carbide is completely inactive to insertion of lithium, and therefore when silicon carbide is generated, the charge-discharge capacity of the active material is reduced. For causing zirconia to undergo phase transition to a tetragonal crystal, the temperature of the disproportionation reaction is preferably 1000° C. or higher. Therefore, the temperature of firing is preferably 1000° C. to 1400° C. (inclusive), further preferably 1000° C. to 1100° C. (inclusive). This is because when the firing temperature is lower than 1000° C., phase transition of zirconia to a tetragonal crystal does not sufficiently proceed, and when the firing temperature is higher than 1400° C., zirconia particles may be progressively fused to be coarsened as compared to silicon oxide particles. The firing time is preferably about 1 to 12 hours.

(Carbon Coating Treatment: S03)

Particles as a composite obtained by a compounding treatment may be coated with carbon after the compounding treatment and before the firing treatment. As a material to be used for coating, one that is formed into the carbonaceous substance 101 when heated under an inert atmosphere, such as pitch, a resin or a polymer can be used. Specifically, one that is well carbonized by firing at about 1200° C., such as petroleum pitch, mesophase pitch, a furan resin, cellulose or a rubber, is preferred. This is because firing cannot be performed at a temperature higher than 1400° C. as described in the section of “Firing Treatment”.

As a coating method, a monomer is polymerized with composite particles dispersed therein, and solidified, and the resulting product is subjected to firing. Alternatively, a polymer is dissolved in a solvent, composite particles are dispersed, the solvent is then evaporated, and the resulting solid is subjected to firing. As another method to be used for carbon coating, carbon coating by CVD can also be performed. This method is a method in which a gas carbon source is passed over a sample heated to 800 to 1000° C. using an inert gas as a carrier gas, thereby performing carbonization on the surface of the sample. In this case, benzene, toluene, styrene or the like can be used as the carbon source.

At the time of the carbon coating treatment and compounding treatment, alkoxide, a Li compound and carbon fibers may be added at the same time.

The negative electrode active material 100 according to this embodiment is obtained by the above-mentioned synthesis method. The particle diameter and specific surface area etc. of the product after carbonization and firing may be adjusted using various kinds of mills, a grinding apparatus, a grinder or the like.

### Second Embodiment

A nonaqueous electrolyte secondary battery according to the second embodiment will be described.

The nonaqueous electrode secondary battery according to the second embodiment includes an exterior material, a positive electrode stored in the exterior material, a negative electrode containing an active material, the negative electrode stored so as to be spatially separated from the positive electrode, e.g. with a separator interposed therebetween, in the exterior material, and a nonaqueous electrolyte filled in the exterior material.

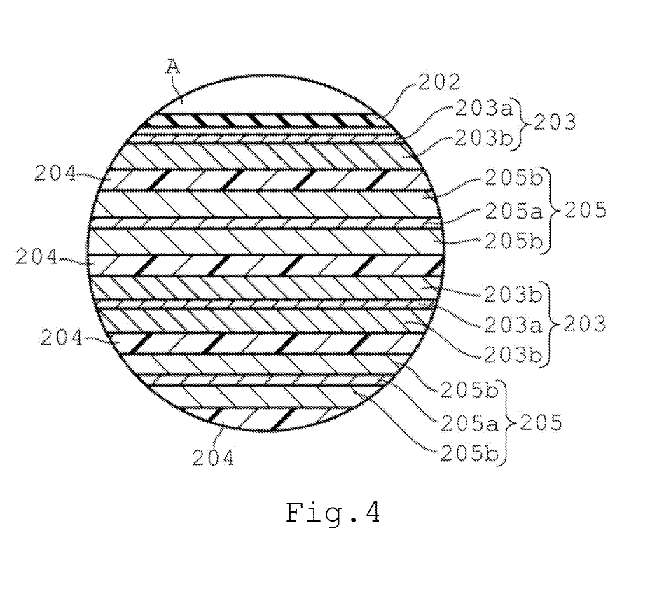

The nonaqueous electrolyte secondary battery will be described more in detail with reference to the conceptual views of FIGS. 3 and 4 that illustrate a nonaqueous electrolyte secondary battery 200 according to the embodiment. FIG. 3 is a conceptual sectional view of the flat-type nonaqueous electrolyte secondary battery 200 with a bag-shaped exterior material 202 formed of a laminate film, and FIG. 4 is an enlarged sectional view of the A part in FIG. 3. The figures are conceptual views for explanations, and the shape, dimension and scale therein may be different from those of actual apparatuses, but they can be appropriately design-changed by referring to the following descriptions and publicly known techniques.

A flat winding electrode group 201 is stored in the bag-shaped exterior material 202 formed of a laminate film with an aluminum foil interposed between two resin layers. The flat winding electrode group 201 is formed by winding in a coiled manner a stacked product with a negative electrode 203, a separator 204, a positive electrode 205 and the separator 204 stacked in this order from the outside, and performing press-molding. The negative electrode 203 at the outermost shell has a configuration in which a negative electrode mixture 203b is formed on one surface of a negative electrode current collector 203a on the inner surface side as illustrated in FIG. 4. The other negative electrode 203 is configured such that the negative electrode mixture 203b is formed on each of both surfaces of the negative electrode current collector 203a. An active material in the negative electrode mixture 203b includes the active material for a battery according to the first embodiment. The positive electrode 205 is configured such that a positive electrode mixture 205b is formed on each of both surfaces of a positive electrode current collector 205a.

In the vicinity of the outer peripheral of the winding electrode group 201, a negative electrode terminal 206 is electrically connected to the negative electrode current collector 203a of the negative electrode 203 at the outermost shell, and a positive electrode terminal 207 is electrically connected to the positive electrode current collector 205a of the positive electrode 205 on the inner side. The negative electrode terminal 206 and positive electrode terminal 207 are protruded to the outside from an opening of the bag-shaped exterior material 202. For example, a liquid nonaqueous electrolyte is injected from the opening of the bag-shaped exterior material 202. The opening of the bag-shaped exterior material 202 is heat-sealed with the negative electrode terminal 206 and the positive electrode terminal 207 sandwiched therein to completely seal the winding electrode group 201 and the liquid nonaqueous electrolyte.

The negative electrode terminal 206 includes, for example, aluminum or an aluminum alloy containing elements such as Mg, Ti, Zn, Mn, Fe, Cu and Si. Preferably the negative electrode terminal 206 is formed of a material similar to that of the negative electrode current collector 203a for reducing the contact resistance with the negative electrode current collector 203a.

For the positive electrode terminal 207, a material having electrical stability at an electric potential of 3 to 4.25 V to a lithium ion metal, and conductivity can be used. Specific examples include aluminum and aluminum alloys containing elements such as Mg, Ti, Zn, Mn, Fe, Cu and Si. Preferably the positive electrode terminal 207 is formed of a material similar to that of the positive electrode current collector 205a for reducing the contact resistance with the positive electrode current collector 205a.

The bag-shaped exterior material 202, the positive electrode 205, the negative electrode 203, the electrolyte and the separator 204, which are constituent members of the nonaqueous electrolyte secondary battery 200, will be described in detail below.

1) Bag-Shaped Exterior Material 202

The bag-shaped exterior material 202 is formed of a laminate film having a thickness of 0.5 mm or less. Alternatively, for the exterior material, a metallic container having a thickness of 1.0 mm or less is used. More preferably the metallic container has a thickness of 0.5 mm or less.

The shape of the bag-shaped exterior material 202 can be selected from a flat type (thin type), a rectangular type, a cylindrical type, a coin type and a button type. Examples of the exterior material include, depending on a battery size, exterior materials for small batteries that are mounted in portable electronic devices etc. and exterior materials for large batteries that are mounted in two to four-wheeled automobiles etc.

For the laminate film, a multilayer film with a metal layer interposed between resin layers is used. The metal layer is preferably an aluminum foil or an aluminum alloy foil for reduction of weight. For the resin layer, for example, a polymer material such as polypropylene (PP), polyethylene (PE), nylon or polyethylene terephthalate (PET) can be used. The laminate film can be formed into a shape of the exterior material by sealing the film by heat sealing.

The metallic container is made from aluminum, an aluminum alloy or the like. The aluminum alloy is preferably an alloy containing elements such as magnesium, zinc, silicon and the like. When transition metals such as iron, copper, nickel and chromium are contained in the alloy, the amount thereof is preferably 100 ppm by mass or less.

2) Positive Electrode 205

The positive electrode 205 has a structure in which the positive electrode mixture 205b containing an active material is carried on one or both of the surfaces of the positive electrode current collector 205a.

The thickness of the positive electrode mixture 205b on one surface is desired to be in a range of 0.1 μm to 150 μm for retaining the large current discharge characteristics and cycle life of the battery. Therefore, the total thickness of the positive electrode mixture 205b is desired to be in a range of 20 μm to 300 μm when it is carried on both the surfaces of the positive electrode current collector 205a. The thickness on one surface is more preferably in a range of 30 μm to 120 μm. When the thickness is in this range, the large current discharge characteristics and cycle life are improved.

The positive electrode mixture 205b may contain a conducting agent in addition to a positive electrode active material.

Further, the positive electrode mixture 205b may contain a binder for binding positive electrode materials.

Use of various kinds of oxides, for example manganese dioxide, a lithium manganese composite oxide, a lithium-containing nickel cobalt oxide (e.g. LiCOO₂), a lithium-containing nickel cobalt oxide (e.g. LiNi_{0.8}CO_{0.2}O₂) and a lithium manganese composite oxide (e.g. LiMn₂O₄ and LiMnO₂) as the positive electrode active material is preferred because a high voltage can be obtained.

Examples of the conducting agent may include acetylene black, carbon black and graphite.

As a specific example of the binder, polytetrafluoroethylene (PTFE), polyvinylidene fluoride (PVdF), an ethylene-propylene-diene copolymer (EPDM), styrene-butadiene rubber (SBR) or the like can be used.

The blending ratio of the positive electrode active material, the conducting agent and the binder is preferably in a range of 80 to 95% by mass for the positive electrode active material, 3 to 20% by mass for the conducting agent and 2 to 7% by mass for the binder because proper large current discharge characteristics and a proper cycle life can be obtained.

For the current collector 205a, a conductive board of porous structure or a nonporous conductive board can be used. The thickness of the current collector is desired to be 5 to 20 μm. This is because when the thickness is in this range, a balance can be maintained between the electrode strength and weight reduction.

The positive electrode 205 is prepared by, for example, suspending an active material, a conducting agent and a binder in a commonly used solvent to prepare slurry, applying the slurry to the current collector 205a, drying the slurry and then performing pressing. The positive electrode 205 may also be prepared by forming an active material, a conducting agent and a binder into a pellet shape to obtain the positive electrode mixture 205b, and forming the positive electrode mixture 205b on the current collector 205a.

3) Negative Electrode 203

The negative electrode 203 has a structure in which the negative electrode mixture 203b containing a negative electrode active material and other negative electrode materials is carried on one or both of the surfaces of the negative electrode current collector 203a in a layered form. For the negative electrode active material, the negative electrode active material 100 according to the first embodiment is used.

The thickness of the negative electrode mixture 203b is desired to be in a range of 0.1 to 150 μm. Therefore, the total thickness of the negative electrode mixture 203b is in a range of 20 to 300 μm when it is carried on both the surfaces of the negative electrode current collector 203a. The thickness on one surface is more preferably in a range of 30 to 100 μm. When the thickness is in this range, the large current discharge characteristics and cycle life are considerably improved.

The negative electrode mixture 203b may contain a binder for binding negative electrode materials. As the binder, for example, polytetrafluoroethylene (PTFE), polyvinylidene fluoride (PVdF), an ethylene-propylene-diene copolymer (EPDM), styrene-butadiene rubber (SBR), polyimide, polyaramide, polyacrylonitrile, polyacrylic acid or the like can be used. For the binder, two or more substances may be used in combination, and when a combination of a binder excellent in binding of active materials and a binder excellent in binding of an active material and a current collector, or a combination of a binder having a high hardness and a binder excellent in flexibility is used, a negative electrode excellent in life characteristics can be prepared.

The negative electrode mixture 203b may contain a conducting agent. Examples of the conducting agent may include acetylene black, carbon black and graphite.

For the current collector 203a, a conductive board of porous structure or a nonporous conductive board can be used. Such a conductive board can be formed from, for example, copper, stainless steel or nickel. The thickness of the current collector 203a is desired to be 5 to 20 μm. This is because when the thickness is in this range, a balance can be maintained between the electrode strength and weight reduction.

The negative electrode 203 is prepared by, for example, suspending an active material, a conducting agent and a binder in a commonly used solvent to prepare slurry, applying the slurry to the current collector 203a, drying the slurry and then performing pressing. The negative electrode 203 may also be prepared by forming an active material, a conducting agent and a binder into a pellet shape to obtain the negative electrode mixture 203b, and forming the negative electrode mixture 203b on the current collector 203a.

The blending ratio of the negative electrode active material, the conducting agent and the binder is preferably in a range of 80 to 95% by mass for the negative electrode active material, 3 to 20% by mass for the conducting agent and 2 to 7% by mass for the binder because proper large current discharge characteristics and a proper cycle life can be obtained.

4) Electrolyte

As the electrolyte, a nonaqueous electrolyte solution, an electrolyte-impregnated-type polymer electrolyte, a polymer electrolyte or an inorganic solid electrolyte can be used.

The nonaqueous electrolyte solution is a liquid electrolyte solution prepared by dissolving an electrolyte in a nonaqueous solvent, and is held in voids in the electrode group.

As the nonaqueous solvent, it is preferred to use a nonaqueous solvent having as a principal component a mixed solvent of propylene carbonate (PC) or ethylene carbonate (EC) and a nonaqueous solvent having a viscosity lower than that of PC or EC (hereinafter, referred to as a second solvent).

As the second solvent, for example chain carbon is preferred, and examples thereof include dimethyl carbonate (DMC), methyl ethyl carbonate (MEC), diethyl carbonate (DEC), ethyl propionate, methyl propionate, γ-butyrolactone (BL), acetonitrile (AN), ethyl acetate (EA), toluene, xylene and methyl acetate (MA). These second solvents may be used alone or in the form of a mixture of two or more thereof. Particularly, more preferably the second solvent has a donor number of 16.5 or less.

The viscosity of the second solvent is preferably 2.8 crap or less at 25° C. The blending amount of ethylene carbonate or propylene carbonate in the mixed solvent is preferably 1.0% to 80% in terms of a volume ratio. The blending amount of ethylene carbonate or propylene carbonate in the mixed solvent is more preferably 20% to 75% in terms of a volume ratio.

Examples of the electrolyte contained in the nonaqueous electrolyte solution include lithium salts (electrolytes) such as lithium perchlorate (LiClO₄), lithium hexafluorophosphate (LiPF₆), lithium borofluoride (LiBF₄), lithium hexafluoroarsenide (LiAsF₆), lithium trifluorometasulfonate (LiCF₃SO₃) and bistrifluoromethylsulfonylimide lithium [LiN(CFSO₂)₂]. Among them, it is preferred to use LiPF₆ or LIBF₄.

The amount of the electrolyte dissolved in the nonaqueous solvent is desired to be 0.5 to 2.0 mol/L.

5) Separator 204

When a nonaqueous electrolyte solution is used and when an electrolyte-impregnated-type polymer electrolyte is used, the separator 204 can be used. For the separator 204, a porous separator is used. As a material of the separator 204, for example, a porous film including polyethylene, polypropylene or polyvinylidene fluoride (PVdF), a synthetic resin nonwoven fabric, or the like can be used. Particularly, a porous film formed of polyethylene or polypropylene or both is preferred because safety of the secondary battery can be improved.

The thickness of the separator 204 is preferably 30 μm or less. When the thickness is more than 30 μm, the distance between positive and negative electrodes may become large, leading to an increase in internal resistance. The lower limit value of the thickness is preferably 5 μm. When the thickness is less than 5 μm, the strength of the separator 204 may be significantly reduced to cause an internal short-circuit to easily occur. The upper limit value of the thickness is more preferably 25 μm, and the lower limit value is more preferably 1.0 μm.

Preferably the separator 204 has a thermal shrinkage rate of 20% or less when left standing at 120° C. for 1 hour. When the thermal shrinkage rate is more than 20%, the possibility is increased that short-circuit occurs upon heating. The thermal shrinkage rate is more preferably 15% or less.

Preferably the separator 204 has a porosity of 30 to 70%. The reason for this is as follows. When the porosity is less than 30%, it may be difficult to achieve high electrolyte retainability in the separator 204. On the other hand, when the porosity is more than 60%, a sufficient strength of the separator 204 may not be achieved. The porosity is more preferably in a range of 35 to 70%.

Preferably the separator 204 has an air permeability of 500 seconds/100 cm³ or less. When the air permeability is more than 500 seconds/100 cm³, it may be difficult to achieve high lithium ion mobility in the separator 204. The lower limit value of the air permeability is 30 seconds/100 cm³. This is because when the air permeability is less than 30 seconds/100 cm³, sufficient separator strength may not be achieved.

The upper limit value of the air permeability is more preferably 300 seconds/100 cm³, and the lower limit value is more preferably 50 seconds/100 cm³.

### Third Embodiment

Next, a battery pack according to the third embodiment will be described.

The battery pack according to the third embodiment includes one or more nonaqueous electrolyte secondary batteries (i.e. single batteries) according to the second embodiment. When a plurality of single batteries is included in the battery pack, the single batteries are disposed so as to be electrically connected in series, in parallel, or in series and in parallel.

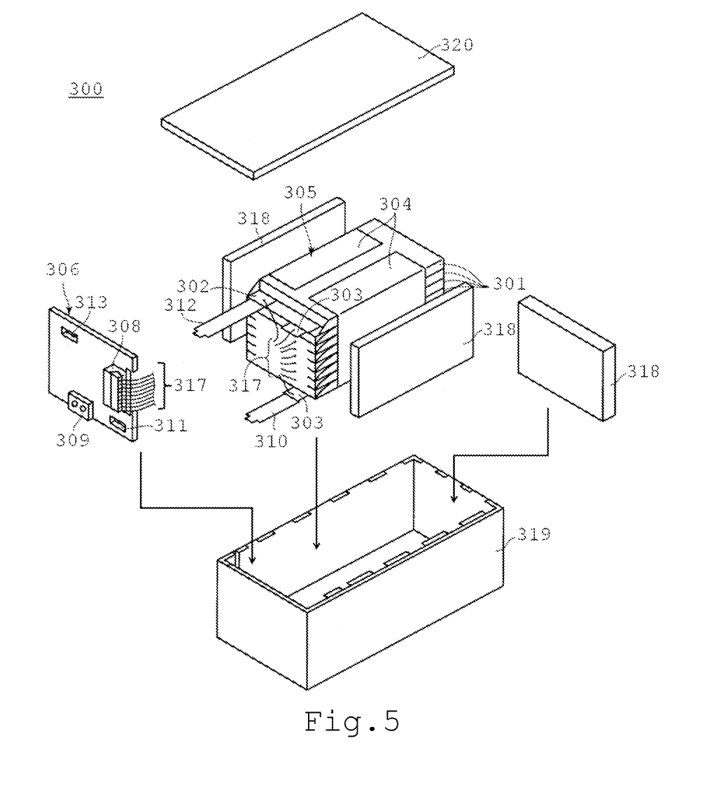

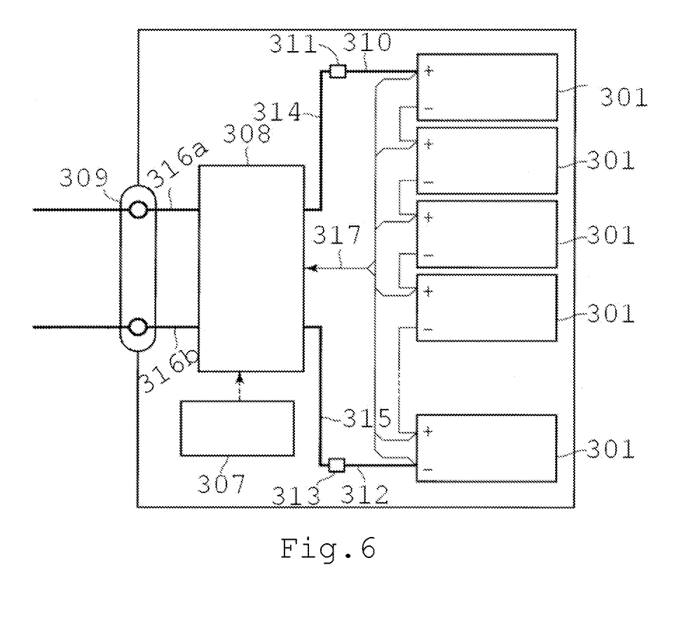

A battery pack 300 will be described in detail with reference to FIGS. 5 and 6. In the battery pack 300 illustrated in FIG. 5, a flat-type nonaqueous electrolyte secondary battery 200 shown in FIG. 3 is used as a single battery 301.

A plurality of single batteries 301 is stacked such that a negative electrode terminal 302 and a positive electrode terminal 303 which are protruded to the outside are aligned in the same direction, and the single batteries are fastened by an adhesive tape 304 to form an assembled battery 305. These single batteries 301 are mutually electrically connected in series as illustrated in FIG. 6.

A print wiring board 306 is disposed so as to face the side surface of the single battery 301 where the negative electrode terminal 302 and the positive electrode terminal 303 are extended. A thermistor 307, a protective circuit 308 and a terminal 309 for electric conduction to external devices are mounted on the print wiring board 306 as illustrated in FIG. 6. For avoiding unnecessary connection to wiring of the assembled battery 305, an insulation plate (not illustrated) is attached on a surface of the print wiring board 306 which faces the assembled battery 305.

A positive electrode-side lead 310 is connected to the positive electrode terminal 303 positioned at the lowermost layer of the assembled battery 305, and its tip is inserted into a positive electrode-side connector 311 of the print wiring board 306 to be electrically connected thereto. A negative electrode-side lead 312 is connected to the negative electrode terminal 302 positioned at the uppermost layer of the assembled battery 305, and its tip is inserted into a negative electrode-side connector 313 of the print wiring board 306 to be electrically connected thereto. The connectors 311 and 313 are connected to the protective circuit 308 through wirings 314 and 315 formed on the print wiring board 306.

The thermistor 307 is used for detecting a temperature of the single battery 305, and a detection signal thereof is sent to the protective circuit 308. The protective circuit 308 can disconnect positive-side wiring 316a and negative-side wiring 316b between the protective circuit 308 and the terminal 309 for electric conduction to external devices at a predetermined condition. The predetermined condition means a time when the detected temperature of, for example, the thermistor 307 reaches a temperature equal to or higher than a predetermined temperature. Further, the predetermined condition means a time when overcharge, overdischarge, overcurrent or the like of the single battery 301 is detected. The detection of overcharge etc. is performed on individual single batteries 301 or the whole of single batteries 301. When detection is performed on individual single batteries 301, a battery voltage may be detected, or a positive electrode potential or a negative electrode potential may be detected. In the latter case, a lithium electrode to be used as a reference electrode is inserted into each of individual single batteries 301. In the case of FIGS. 5 and 6, wiring 317 for voltage detection is connected to each of single batteries 301, a detection signal is sent to the protective circuit 308 through the wiring 317.

A protective sheet 318 formed of rubber or resin is disposed on each of three side surfaces of the assembled battery 305 which do not include a side surface where the positive electrode terminal 303 and the negative electrode terminal 302 are protruded.

The assembled battery 305 is stored in a storage container 319 together with the protective sheets 318 and the print wiring board 306. That is, the protective sheet 318 is disposed on each of both inner side surfaces of the storage container 319 in the long side direction and an inner side surface of the storage container 319 in the short side direction, and the print wiring board 306 is disposed on an inner side surface on the opposite side in the short side direction. The assembled battery 305 is positioned in a space surrounded by protective sheets 318 and the print wiring board 306. A lid 320 is mounted on the upper surface of the storage container 319.

For fixation of the assembled battery 305, a thermally shrinkable tape may be used in place of the adhesive tape 304. In this case, a protective sheet is disposed on each of both side surfaces of the assembled battery, a thermally shrinkable tape is wound, and the thermally shrinkable tape is then thermally shrunk to bind the assembled battery.

FIGS. 5 and 6 illustrate a configuration in which single batteries 301 are connected in series, but for increasing the battery capacity, single batteries 301 may be connected in parallel, or connection in series and connection in parallel may be combined. Assembled battery packs can also be further connected in series or in parallel.

According to the embodiment described above, there can be provided a battery pack which includes a nonaqueous electrolyte secondary battery having excellent charge-discharge cycle performance in the third embodiment and therefore has excellent charge-discharge cycle performance.

The aspect of the battery pack is appropriately changed according to an application. Battery packs to be applied are preferably those that exhibit excellent cycle characteristics when a large current is extracted. Specific examples include those for power supplies of digital cameras and those to be mounted on vehicles such as two to four wheeled hybrid electric cars, two to four wheeled electric cars and assisted bicycles. Particularly, battery packs using a nonaqueous electrolyte secondary battery excellent in high temperature characteristics are suitably used for vehicle-mounting applications.

Hereinafter, specific examples (examples of specifically preparing the battery described in FIG. 3 under respective conditions described in examples) will be shown, and effect thereof will be described.

### Example 1

SiO was ground under the following conditions, the ground product, a carbon material and a zirconia compound were mixed/kneaded, and the mixture was fired in an Ar gas to obtain an active material.

98 parts by mass of S10 having an average primary particle diameter of 22.6 μm and 2 parts by mass of yttria-doped monoclinic zirconia having an average particle diameter of 2.0 were weighed, and ground and mixed in the following manner. A grinding treatment was performed for 6 hours with ethanol as a dispersion medium using beads having a bead diameter of 0.5 mm in a continuous bead mill apparatus. The grinding-treated product had an average primary particle diameter of 0.5 μm. Next, to a mixed liquid of 4.0 g of furfuryl alcohol, 10 g of ethanol and 0.125 g of water were added 2.8 g of the grinding-treated product, 0.5 g of a graphite powder having an average primary particle diameter of 3 μm and 0.08 g of carbon fibers having an average diameter of 180 nm, and the mixture was subjected to a mixing/kneading treatment in a kneader to form slurry. 0.2 g of dilute hydrochloric acid as a polymerization catalyst for furfuryl alcohol was added to the slurry after mixing/kneading, and the mixture was left standing at room temperature for 18 hours, and thereby dried and solidified to obtain a carbon composite.

The obtained carbon composite was fired in an Ar gas at 1100° C. for 3 hours, cooled to room temperature, and sieved over a screen with a mesh size of 30 μm to obtain a negative electrode active material under the screen.

For the active material obtained in Example 1, a charge-discharge test, X-ray diffraction measurement and ICP measurement described below were conducted to evaluate charge-discharge characteristics and physical properties.

77 parts by mass of the obtained sample, 15 parts by mass of graphite having an average diameter of 3 μm and 8 parts by mass of polyimide were put in a dispersion medium, mixed/kneaded, the mixture was applied onto a copper foil having a thickness of 12 μm, and the coated copper foil was rolled. N-methylpyrrolidone was used as the dispersion medium. After rolling, the coated copper foil was heat-treated in an Ar gas at 250° C. for 2 hours, cut into a predetermined size, and then dried under vacuum at 100° C. for 12 hours to form a test electrode. A battery using metal Li for a counter electrode and a reference electrode and an EC/DEC (volume ratio of EC:DEC=1:2) solution of LiPF₆ (1 M) as an electrolyte solution was prepared in an argon atmosphere.

(Charge-Discharge Test)

For this battery, a charge-discharge test was conducted. For conditions for the charge-discharge test, the battery was charged at a current density of 1 mA/cm² up to a potential difference of 0.01 V between the reference electrode and the test electrode, further charged with a constant voltage at 0.01 V for 16 hours, and discharged at a current density of 1 mA/cm² up to 1.5 V. The cycle under this condition was conducted three times, a charge-discharge cycle was conducted under the same condition with the current value set to 2.5 mA/cm², and a ratio of a discharge capacity at 2.5 mA/cm² and a discharge capacity at 1 mA/cm² was calculated. Further, a cycle including charging the battery at a current density of 1 mA/cm² up to a potential difference of 0.01 V between the reference electrode and the test electrode and discharging the battery at a current density of 1 mA/cm² up to 1.5 V was conducted 200 times, and a retention rate of the discharge capacity at the 100th cycle to that in the first cycle was measured.

(X-Ray Diffraction Measurement)

For the obtained powder sample, powder X-ray diffraction measurement was performed to determine a full width at half maximum of the peak of the Si (220) plane. The measurement was performed under the following conditions using an X-ray diffractometer (Model: M18XHF22) manufactured by Mac Science Co., Ltd.).

Counter negative electrode: Cu
Tube voltage: 50 kV
Tube current: 300 mA
Scanning speed: 1° (2θ)/min
Time constant: 1 sec
Light reception slit: 0.15 mm
Divergence slit: 0.5°
Scattering slit: 0.5°

A full width at half maximum (2θ) of a peak of the plane index (220) of Si, which appeared at d=1.92 Å (2θ=47.2° was measured from the diffraction pattern. In the case where the peak of Si (220) overlapped a peak of any other substance contained in the active material, the peak was isolated and a full width at half maximum was measured. Presence/absence of a diffraction peak at 2θ=30°, 50° and 60° was checked, and an area A of a peak of the plane index (111) of Si and an area B of a peak at 2θ=30° originating from ZrO₂ were measured to calculate a ratio of B/A.

(ICP Measurement)

The obtained active material was dissolved in a mixed liquid of nitric acid, hydrofluoric acid and sulfuric acid at 230° C., and the acids were volatilized until only sulfuric acid remained, so that the volume was fixed to prepare a sample for ICP measurement for quantitative determination of Zr. Using sodium carbonate, the active material was similarly dissolved in alkali to prepare a sample for ICP measurement for quantitative determination of Si. For the prepared sample for measurement, Si and Zr were quantitatively determined by ICP-AES to calculate a Zr/Si molar ratio.

Table 1 shows the discharge capacity in the charge-discharge test, the capacity retention rate of the discharge capacity after 200 cycles to the discharge capacity in the first cycle, presence/absence of a diffraction peak at 2θθ=30°, 50° and 60° obtained from powder X-ray diffraction, the ratio (B/A) of an area A of a peak of the plane index (111) of Si and an area B of a peak at 2θ=30° originating from tetragonal crystal system ZrO₂, the full width at half maximum measurement result for a Si (220) peak, and the Zr/Si molar ratio obtained from ICP measurement.

Results for the following examples and comparative example are summarized in Table 1 below. The following examples and comparative example are described only formatters that are different from Example 1, and other synthesis and evaluation procedures are similar to those in Example 1, and therefore descriptions thereof are omitted.

### Example 2

An active material was obtained by performing synthesis in the same manner as in Example 1 except that the amount SiO was 99 parts by mass, and the amount of the yttria-doped monoclinic zirconia powder was 1 part by mass.

### Example 3

An active material was obtained by performing synthesis in the same manner as in Example 1 except that the amount SiO was 99.8 parts by mass, and the amount of the yttria-doped monoclinic zirconia powder was 0.2 parts by mass.

### Example 4

An active material was obtained by performing synthesis in the same manner as in Example 1 except that the amount SiO was 90 parts by mass, and the amount of the yttria-doped monoclinic zirconia powder was 10 parts by mass.

### Example 5

An active material was obtained by performing synthesis in the same manner as in Example 1 except that the amount SiC was 83 parts by mass, and the amount of the yttria-doped monoclinic zirconia powder was 17 parts by mass.

### Example 6

An active material was obtained by performing synthesis in the same manner as in Example 1 except that the amount SiO was 70 parts by mass, and the amount of the yttria-doped monoclinic zirconia powder was 30 parts by mass.

### Example 7

An active material was obtained by performing synthesis in the same manner as in Example 1 except that the amount SiC was 65 parts by mass, and the amount of the yttria-doped monoclinic zirconia powder was 45 parts by mass.

### Comparative Example 1

An active material was obtained by performing synthesis in the same manner as in Example 1 except that the yttria-doped monoclinic zirconia powder was not added at the time of grinding treatment.

TABLE 1
A

| | FIRING | FIRING | XRD PEAK |
|---|---|---|---|
| | TEMPERATURE | TIME | 2θ = 30° |
| | (° C.) | (hr) | (—) |
| Example 1 | 1100 | 3 | PRESENT |
| Example 2 | 1100 | 3 | PRESENT |
| Example 3 | 1100 | 3 | PRESENT |
| Example 4 | 1100 | 3 | PRESENT |
| Example 5 | 1100 | 3 | PRESENT |
| Example 6 | 1100 | 3 | PRESENT |
| Example 7 | 1100 | 3 | PRESENT |
| Comparative | 1100 | 3 | ABSENT |
| Example 1 | | | |

B

| | | | | Si (220) PEAK |
|---|---|---|---|---|
| | | B/A | Zr/Si | FULL WIDTH |
| | XRD PEAK | (XRD PEAK | ELEMENT | AT HALF |
| | 2θ = 50, | AREA) | RATIO | MAXIMUM |
| | 60° (—) | (—) | (—) | (°) |
| Example 1 | PRESENT | 0.01 | 0.38 | 1.5 |
| Example 2 | PRESENT | 0.005 | 0.20 | 1.5 |
| Example 3 | PRESENT | 0.001 | 0.04 | 1.5 |
| Example 4 | PRESENT | 0.05 | 0.66 | 1.5 |
| Example 5 | PRESENT | 0.1 | 0.85 | 1.2 |
| Example 6 | PRESENT | 0.2 | 1.03 | 1.2 |
| Example 7 | PRESENT | 0.4 | 1.60 | 1.2 |
| Comparative | ABSENT | 0.0 | — | 1.5 |
| Example 1 | | | | |

C

| | DISCHARGE | RETENTION | |
|---|---|---|---|
| | CAPACITY | FATE | LARGE CURRENT |
| | (mAh/g) | (%) | CHARACTERISTICS |
| Example 1 | 1006 | 89 | 90 |
| Example 2 | 1015 | 86 | 92 |
| Example 3 | 1021 | 85 | 91 |
| Example 4 | 988 | 91 | 90 |
| Example 5 | 932 | 93 | 85 |
| Example 6 | 880 | 95 | 72 |
| Example 7 | 612 | 97 | 60 |
| Comparative | 1015 | 76 | 91 |
| Example 1 | | | |

RETENTION RATE: Cycle characteristics capacity RETENTION RATE after 200 cycles (%)

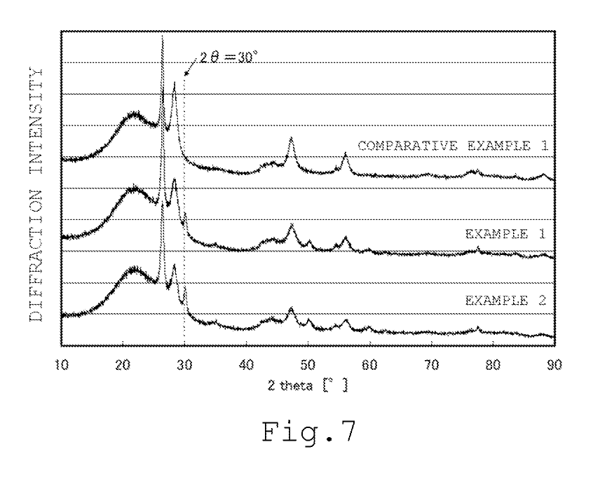

FIG. 7 illustrates XRD diffraction patterns in examples and comparative example. Diffraction patterns in examples in which zirconia is added have diffraction peaks at 2θ=30° and 50° and 60° unlike the sample of comparative example.

As is apparent from Table 1, secondary batteries including the negative electrode active materials of Examples 1 to 7, each of which is a composite including a silicon oxide dispersed in a carbonaceous substance and silicon dispersed in the silicon oxide and has a diffraction peak at 2θ=30° in powder X-ray diffraction measurement, is excellent in capacity retention rate in the 200th cycle and therefore has a long life. It can be understood that particularly the active materials of Examples 1 to 4 are excellent in both discharge capacity and large current characteristics in addition to life characteristics.

On the other hand, the negative electrode active material of Example 1 having no diffraction peak at 2θ=30° had a low capacity retention rate in the 100th cycle as compared to Examples 1 to 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A negative electrode active material for a nonaqueous electrolyte secondary battery comprising:
a carbonaceous substance;
a silicon oxide phase in the carbonaceous substance;
a silicon phase in the silicon oxide phase; and
a zirconia phase in the carbonaceous substance,
wherein the negative electrode active material has a diffraction peak at 2θ=30±1° in powder X-ray diffraction measurement.

2. The active material according to claim 1, wherein the zirconia phase is a phase comprising tetragonal crystal zirconia or stabilized tetragonal crystal zirconia.

3. The active material according to claim 1, wherein a ratio of an area A of a diffraction peak of the Si (111) plane and an area B of a diffraction peak of the tetragonal crystal system zirconia (101) plane (B/A) in powder X-ray diffraction measurement of the negative electrode active material is 0.05 to 0.5 (inclusive).

4. The active material according to claim 1, wherein a molar ratio of contents of the zirconium element contained in the zirconia phase to the silicon element contained in the silicon oxide phase and silicon phase is 0.001 to 0.2.

5. The active material according to claim 1, wherein a full width at half maximum of a diffraction peak of the Si (220) plane in powder X-ray diffraction measurement is 1.0° to 8.0°.

6. A nonaqueous electrolyte secondary battery comprising:
a negative electrode containing a negative electrode active material;
a positive electrode containing a positive electrode active material; and
a nonaqueous electrolyte,
wherein the negative electrode active material comprises a carbonaceous substance, a silicon oxide phase in the carbonaceous substance, a silicon phase in the silicon oxide phase, and a zirconia phase in the carbonaceous substance,
wherein the negative electrode active material has a diffraction peak at 2θ=30±1° in powder X-ray diffraction measurement.

7. The secondary battery according to claim 6, wherein the zirconia phase is a phase comprising tetragonal crystal zirconia or stabilized tetragonal crystal zirconia.

8. The secondary battery according to claim 6, wherein a ratio of an area A of a diffraction peak of the Si (111) plane and an area B of a diffraction peak of the tetragonal crystal system zirconia (101) plane (B/A) in powder X-ray diffraction measurement of the negative electrode active material is 0.05 to 0.5.

9. The secondary battery according to claim 6, wherein a molar ratio of contents of the zirconium element contained in the zirconia phase to the silicon element contained in the silicon oxide phase and silicon phase is 0.001 to 0.2.

10. The secondary battery according to claim 6, wherein a full width at half maximum of a diffraction peak of the Si (220) plane in powder X-ray diffraction measurement is 1.0° to 8.0°.

11. A battery pack comprising a nonaqueous electrolyte secondary battery,
wherein the nonaqueous electrolyte secondary battery comprises a negative electrode containing a negative electrode active material, a positive electrode containing a positive electrode active material and a nonaqueous electrolyte,
wherein the negative electrode active material comprises a carbonaceous substance, a silicon oxide phase in the carbonaceous substance, a silicon phase in the silicon oxide phase, and a zirconia phase in the carbonaceous substance,
wherein the negative electrode active material has a diffraction peak at 2θ=30±1° in powder X-ray diffraction measurement.

12. The battery pack according to claim 11, wherein the zirconia phase is a phase comprising tetragonal crystal zirconia or stabilized tetragonal crystal zirconia.

13. The battery pack according to claim wherein a ratio of an area A of a diffraction peak of the Si (111) plane and an area B of a diffraction peak of the tetragonal crystal system zirconia (101) plane (B/A) in powder X-ray diffraction measurement of the negative electrode active material is 0.05 to 0.5.

14. The battery pack according to claim 11, wherein a molar ratio of contents of the zirconium element contained in the zirconia phase to the silicon element contained in the silicon oxide phase and silicon phase is 0.001 to 0.2.

15. The battery pack according to claim 11, wherein a full width at half maximum of a diffraction peak of the Si (220) plane in powder X-ray diffraction measurement is 1.0° to 8.0°.
